(19) United States
(12) Patent Application Publication
(10) Pub. No.: US 2009/0195489 A1
(43) Pub. Date: Aug. 6, 2009

(54) Thin film transistor substrate having high aperture ratio and method of manufacturing same

(75) Inventors: Wen-Ming Hung, Miao-Li (TW); Yu-Cheng Lin, Miao-Li (TW); Chien-Cheng Chen, Miao-Li (TW); Chueh-Ju Chen, Miao-Li (TW); Yung-Hsun Wu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/322,487

(22) Filed: Feb. 2, 2009

(30) Foreign Application Priority Data
Feb. 1, 2008 (TW) 97103991

(51) Int. Cl. G09G 3/36

(52) U.S. Cl. 345/92

(57) ABSTRACT

An exemplary TFT substrate (200) includes a plurality of first gate lines (218), a plurality of second gate lines (259), a plurality of data lines (238), a plurality of first pixel electrodes (254) and second pixel electrodes (255), and a plurality of first TFTs (201) and second TFTs (203). Each first pixel electrode is connected to a first gate line and a data line via the first TFT. Each second pixel electrode is connected to a second gate line and a data line via the second TFT. The first gate lines are disposed on a layer different from that of the second gate lines, and overlaps with the second gate lines.

### FIELD OF THE DISCLOSURE

The present invention relates to thin film transistor (TFT) substrates and methods for manufacturing TFT substrates, and particularly to a TFT substrate with a first gate line overlapping with a second gate line and a method for manufacturing such TFT substrate.

### GENERAL BACKGROUND

Liquid crystal displays (LCDs) are widely used nowadays. An LCD generally includes a liquid crystal panel and a backlight module. A TFT substrate is a major component of the liquid crystal panel. To solve a viewing angle problem and overcome a color shift phenomenon, many types of LCDs have been developed. Examples include the multi-domain vertical alignment (MVA) LCD, and the in-plane switching (IPS) LCD. In general, each pixel of the TFT substrate of an MVA LCD or an IPS LCD is generally divided into two sub-pixels. The two sub-pixels are driven by two gate lines respectively.

Referring to FIG. 16, a typical TFT substrate 100 includes a plurality of first gate lines 118, a plurality of second gate lines 119, a plurality of data lines 138, a plurality of first TFTs 101, a plurality of second TFTs 103, a plurality of first pixel electrodes 154, a plurality of second pixel electrodes 155, a plurality of first contact holes 144, and a plurality of second contact holes 145.

The first gate lines 118 and the second gate lines 119 are disposed parallel to each other, and are separated from each other by a predetermined distance. The plurality of data lines 138 are disposed parallel to each other, and substantially perpendicular to the first and the second gate lines 118, 119. Each first TFT 101 is disposed at an intersection of one of the data lines 138 and one of the first gate lines 118. A corresponding second TFT 103 is disposed at an intersection of the same data line 138 and a corresponding second gate line 119. A first gate electrode 116 of the first TFT 101 is connected to the first gate line 118, a first source electrode 134 of the first TFT 101 is connected to the data line 138, and a first drain electrode 135 of the first TFT 101 is connected to the corresponding first pixel electrode 154 via the corresponding first contact hole 144. A second gate electrode 117 of the second TFT 103 is connected to the second gate line 119, a second source electrode 136 of the second TFT 103 is connected to the data line 138, and a second drain electrode 137 of the second TFT 103 is connected to the corresponding second pixel electrode 155 via the corresponding second contact hole 145.

Referring to FIG. 17, this a cross-sectional view of the TFT substrate 100. The first gate electrode 116, the second gate electrode 117, the first gate line 118, and the second gate line 119 are disposed on a glass substrate 111. An insulating layer 121 is formed on the first gate electrode 116, the second gate electrode 117, the first gate line 118, the second gate line 119, and the glass substrate 111. Semiconductor layers 126, each of which having a slit 139, are formed on the insulating layer 121, corresponding to the first gate electrode 116 and the second gate electrode 117, respectively. The first source electrode 134, the first drain electrode 135, the second source electrode 136, and the second drain electrode 137 are formed on the semiconductor layers 126 and the insulating layer 121. A passivation layer 141 is formed on the insulating layer 121, the first source electrode 134, the first drain electrode 135, the second source electrode 136, and the second drain electrode 137. A first contact hole 144 corresponding to the first drain electrode 135 and a second contact hole 145 corresponding to the second drain electrode 137 are formed in the passivation layer 141. The first pixel electrode 154 and the second pixel electrode 155 are formed on the passivation layer 141. The first pixel electrode 154 is connected to the first drain electrode 135 via the first contact hole 144. The second pixel electrode 155 is connected to the second drain electrode 137 via the second contact hole 145.

The first gate line 118 and the second gate line 119 are both disposed on the glass substrate 11 at the same layer, and together occupy a large area of a main face of the glass substrate 11. Thus, the TFT substrate 100 with the above arrangement of the gate lines 118, 119 has a relatively low aperture ratio.

What is needed, therefore, is a TFT substrate that can overcome the above-described deficiencies.

### SUMMARY

In one embodiment, a TFT substrate includes a plurality of first gate lines, a plurality of second gate lines, a plurality of data lines, a plurality of first pixel electrodes and second pixel electrodes, and a plurality of first TFTs and second TFTs. Each first pixel electrode is connected to a first gate line and a data line via the first TFT. Each second pixel electrode is connected to a second gate line and a data line via the second TFT. The first gate lines are disposed on a layer different from that of the second gate lines, and overlaps with the second gate lines.

Other novel features and advantages of the present TFT substrate will become more apparent from the following detailed description when taken in conjunction with the accompanying drawings. In the drawings, all the views are schematic.

### BRIEF DESCRIPTION OF THE DRAWINGS

FIG. 1 is a top plan view of part of a TFT substrate according to a first embodiment of the present invention.

FIG. 2 is a cross-sectional view of the TFT substrate of FIG. 1, taken along line II-II thereof.

FIG. 3 is a flowchart of an exemplary method for manufacturing the TFT substrate of FIG. 1.

FIGS. 4-14 are cross-sectional views showing successive steps for manufacturing the TFT substrate according to the method of FIG. 3.

FIG. 15 is a cross-sectional view of part of a TFT substrate according to a second embodiment of the present invention.

FIG. 16 is a top plan view of part of a conventional TFT substrate.

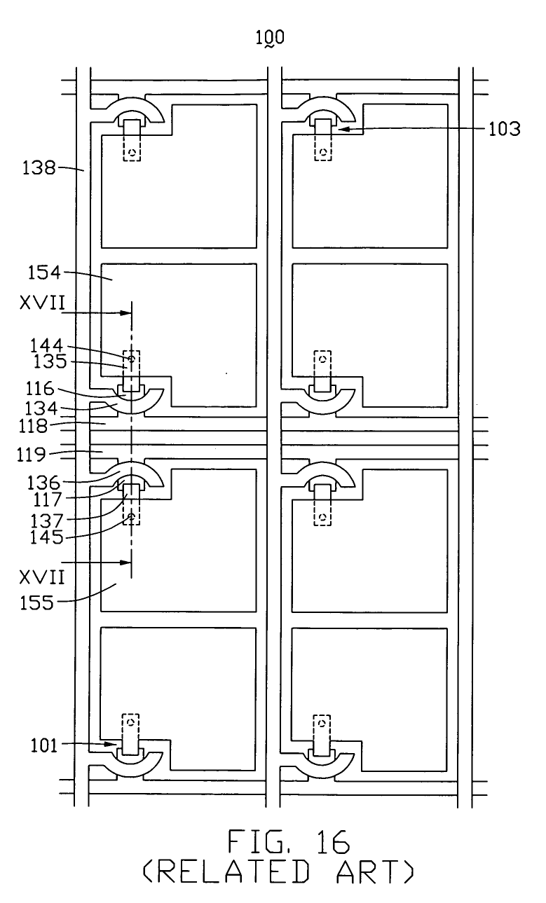

FIG. 17 is a cross-sectional view of the TFT substrate of FIG. 16, taken along line XVII-XVII thereof.

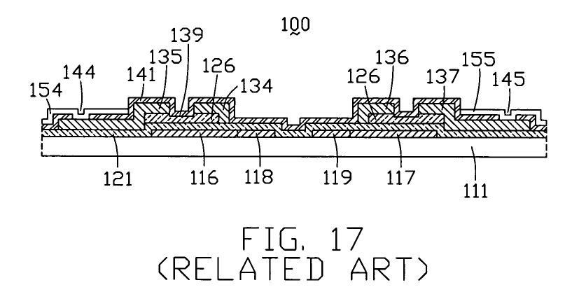

### DETAILED DESCRIPTION OF EMBODIMENTS

Reference will now be made to the drawings to describe various embodiments of the present invention in detail.

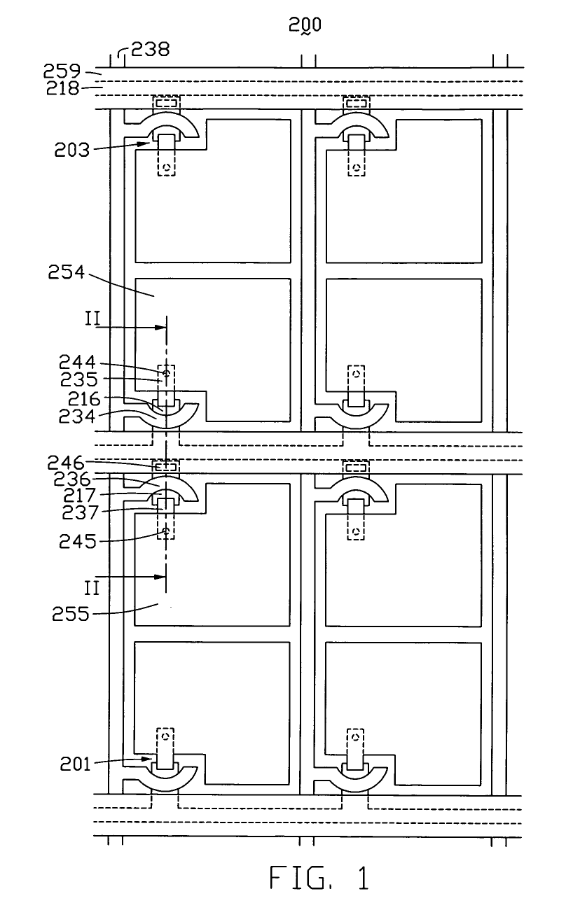

FIG. 1 is a top plan view of part of a thin film transistor (TFT) substrate according to one embodiment of the present invention. The TFT substrate 200 includes a plurality of first gate lines 218, a plurality of second gate lines 259, a plurality of data lines 238, a plurality of first TFTs 201, a plurality of second TFTs 203, a plurality of first pixel electrodes 254, a plurality of second pixel electrodes 255, a plurality of first contact holes 244, a plurality of second contact holes 245, and a plurality of third contact holes 246.

The first gate lines 218 are disposed parallel to each other. The second gate lines 259 are disposed parallel to the first gate lines 218. Each of the second gate lines 259 corresponds to and overlaps one of the first gate lines 218. In this embodiment, each of the second gate lines 259 is disposed over the corresponding first gate line 218, and a width of each second gate line 259 is greater than a width of the corresponding first gate line 218. The first gate lines 218 may be made from material including any one or more items selected from the group consisting of aluminum (Al), molybdenum (Mo), titanium (Ti), copper (Cu), chromium (Cr), and tantalum (Ta). The second gate lines 259 may be made from the same material as the pixel electrodes 254/255, such as indium tin oxide (ITO) or indium zinc oxide (IZO).

The data lines 238 are disposed parallel to each other, and are disposed substantially perpendicular to the first gate lines 218. The data lines 238 are insulated from the first gate lines 218. The data lines 238 and the first gate lines 218 cooperatively define a plurality of pixels (not labeled). Each pixel includes a first TFT 201, a second TFT 203, a first pixel electrode 254, and a second pixel electrode 255.

Each first TFT 201 is disposed at an intersection of one of the data lines 238 and one of the first gate lines 218 (or second gate lines 259). A corresponding second TFT 203 is disposed at the same intersection of the data line 238 and the first gate line 218 (or second gate line 259). A first gate electrode 216 of the first TFT 201 is connected to the first gate line 218. A first source electrode 234 of the first TFT 201 is connected to the data line 238. A first drain electrode 235 of the first TFT 201 is connected to the corresponding first pixel electrode 254 via the corresponding first contact hole 244. A second gate electrode 217 of the second TFT 203 is connected to the second gate line 259 via the corresponding third contact hole 246. A second source electrode 236 of the second TFT 203 is connected to the data line 238. A second drain electrode 237 of the second TFT 203 is connected to the corresponding second pixel electrode 255 via the corresponding second contact hole 245.

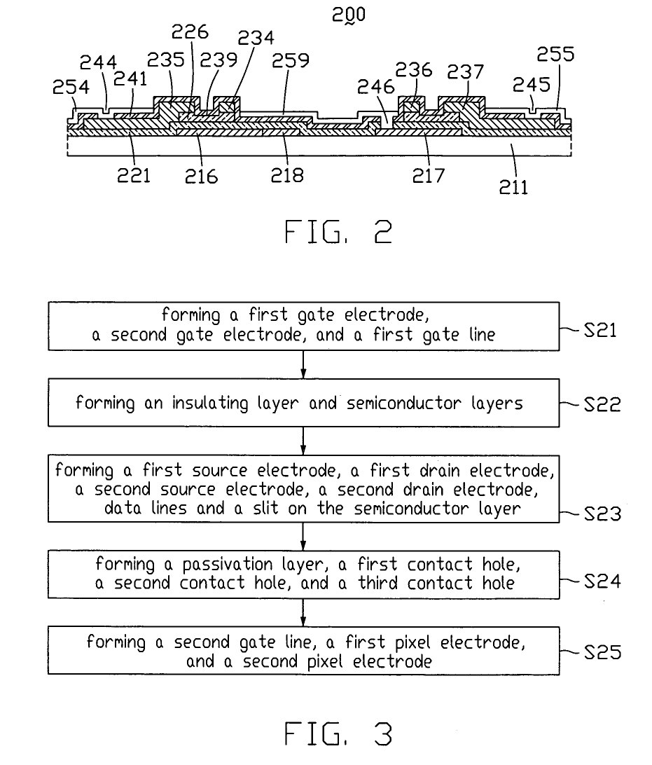

Referring to FIG. 2, this is a cross-sectional view of part of the TFT substrate 200 shown in FIG. 1. The first gate electrode 216, the second gate electrode 217, and the first gate line 218 are disposed on a glass substrate 211. An insulating layer 221 is formed on the first gate electrode 216, the second gate electrode 217, the first gate line 218, and the glass substrate 211. Semiconductor layers 226 are formed on the insulating layer 221, corresponding to the first gate electrode 216 and the second gate electrode 217, respectively. The first source electrode 234, the first drain electrode 235, the second source electrode 236, and the second drain electrode 237 are formed on the semiconductor layers 226 and the insulating layer 221. A passivation layer 241 is formed on the insulating layer 221, the first source electrode 234, the first drain electrode 235, the second source electrode 236, and the second drain electrode 237. The first pixel electrode 254, the second pixel electrode 255, and the second gate line 259 are formed on the passivation layer 241.

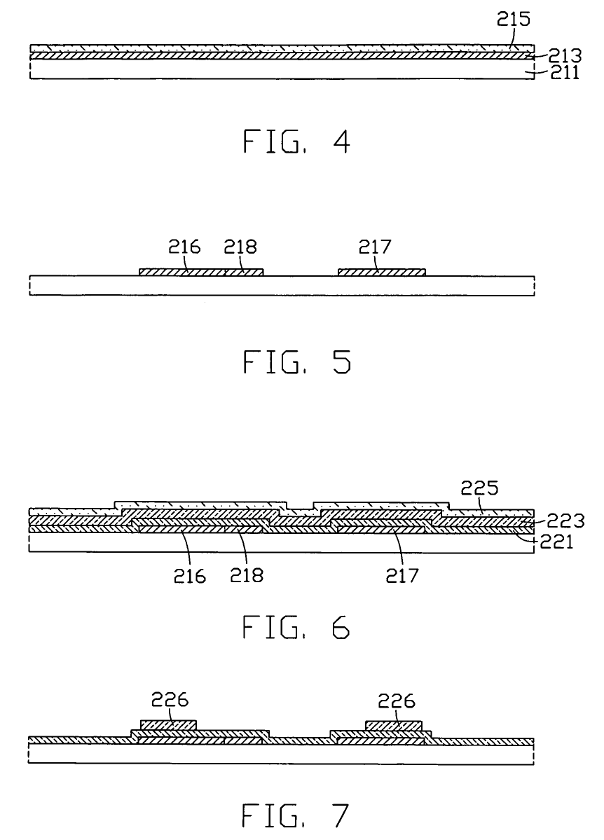

FIG. 3 is a flowchart summarizing an exemplary method for manufacturing the TFT substrate 200. The manufacturing method includes: step S21, forming a first gate electrode, a second gate electrode, and a first gate line; step S22, forming an insulating layer and semiconductor layers; step S23, forming a first source electrode, a first drain electrode, a second source electrode, a second drain electrode, and data lines on the semiconductor layers, and slits in the semiconductor layers; step S24, forming a passivation layer, a first contact hole, a second contact hole, and a third contact hole; and step S25, forming a second gate line, a first pixel electrode, and a second pixel electrode.

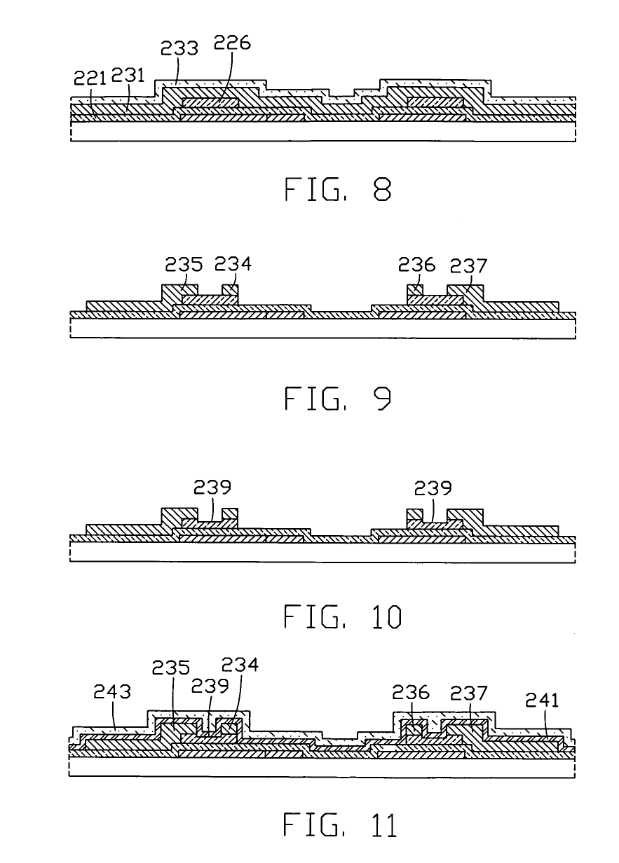

In step S21, referring to FIGS. 4-5, a glass substrate 211 is provided at first. A gate electrode layer 213 and a first photo resist 215 are formed sequentially on the glass substrate 211. The gate electrode layer 213 may have a single-layer structure or a multi-layer structure.

The first photo resist 215 is exposed using a first mask, and then the first photo resist 215 is developed to form a first photo resist pattern (not shown). The gate electrode layer 213 is etched using the first photo resist pattern as a mask, thereby forming the first gate electrode 216, the second gate electrode 217, and the first gate line 218. The first gate electrode 216 is connected to the first gate line 218. Then, the residual first photo resist 215 is removed.

In step S22, referring to FIGS. 6-7, a silicon nitride (SiNx) layer is formed as an insulating layer 221 on the first gate electrode 216, the second gate electrode 217, the first gate line 218 and the glass substrate 211. A semiconductor film 223 and a second photo resist 225 are formed on the insulating layer 221 sequentially. The semiconductor film 223 may include an amorphous silicon film (not labeled) formed on the insulating layer 221, and a heavily doped amorphous silicon film (not labeled) formed on the amorphous silicon film. The second photo resist 225 is exposed using a second mask, and then the second photo resist layer 225 is developed to form a second photo resist pattern (not shown). The semiconductor film 223 is etched using the second photo resist pattern as a mask, thereby forming the semiconductor layers 226, which correspond to the gate electrodes 216, 217. The residual second photo resist 225 is then removed.

In step S23, referring to FIGS. 8-10, an electrode metal layer 231 and a third photo resist layer 233 are formed on the insulating layer 221 and the semiconductor layers 226 sequentially. The third photo resist 233 is exposed using a third mask, and then the third photo resist layer 233 is developed to form a third photo resist pattern (not shown). The electrode metal layer 231 is etched using the third photo resist pattern as a mask, thereby forming the first source electrode 234, the first drain electrode 235, the second source electrode 236, the second drain electrode 237, and the data lines (not shown). The semiconductor layers 226 are further etched to form slits 239. The residual second photo resist 233 is then removed. The first and second source electrodes 234, 236 are connected to the corresponding data lines respectively.

In step S24, referring to FIGS. 11-12, a passivation layer 241 and a fourth photo resist 243 are sequentially formed on the insulating layer 221, the first source electrode 234, the first drain electrode 235, the second source electrode 236, the second drain electrode 237, and the data lines, and in the slit 239. The fourth photo resist 243 is exposed using a fourth mask, and then the fourth photo resist layer 243 is developed to form a fourth photo resist pattern. The passivation layer 241 and the insulating layer 221 are etched using the fourth photo resist pattern as a mask, thereby forming the first contact hole 244, the second contact hole 245, and the third contact hole 246. The first contact hole 244 corresponds to the first drain electrode 235, the second contact hole 245 corresponds to the second drain electrode 237, and the third contact hole 246 corresponds to the second gate electrode 217. The residual fourth photo resist 243 is then removed.

In step S25, referring to FIGS. 13-14, a transparent conductive layer 251 and a fifth photo resist 253 are formed on the passivation layer 241, with the transparent conductive layer 251 filling the three contact holes 244, 245, 246. The fifth photo resist 253 is exposed using a fifth mask, and then the fifth photo resist layer 253 is developed to form a fifth photo resist pattern (not shown). The transparent conductive layer 251 is etched using the fifth photo resist pattern as a mask, thereby forming the second gate line 259, the first pixel electrode 254, and the second pixel electrode 255. The first pixel electrode 254 is connected to the first drain electrode 235 via the first contact hole 244. The second pixel electrode 255 is connected to the second drain electrode 237 via the second contact hole 245. The second gate line 259 is connected to the second gate electrode 217. A portion of the second gate line 259 is located over the first gate line 218. The residual fifth photo resist 253 is then removed.

Unlike in a conventional TFT substrate, the first gate line 218 and the second gate line 259 of the TFT substrate 200 are formed at different layers, with one overlapping the other. In the present embodiment, the second gate line 259 overlaps the first gate line 218. Thus, the first gate lines 218 and the second gate lines 259 together occupy a relatively small area over a main face of the glass substrate 211. Therefore, the TFT substrate 200 can achieve a relatively high aperture ratio.

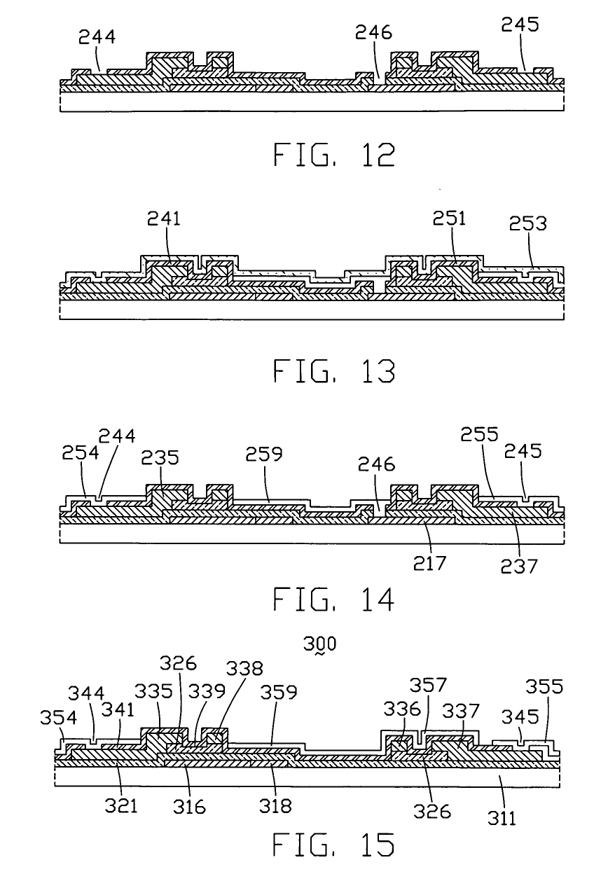

Referring to FIG. 15, this a cross-sectional view of a TFT substrate 300 according to another embodiment of the present invention. A first gate electrode 316 and a first gate line 318 are disposed on a glass substrate 311. An insulating layer 321 is formed on the first gate electrode 316, the first gate line 318, and the glass substrate 311. Semiconductor layers 326, each of which having a slit 339, are formed on the insulating layer 321, with one of the semiconductor layers 326 corresponding to the first gate electrode 316. A first source electrode 338, a first drain electrode 335, a second source electrode 336, and a second drain electrode 337 are formed on the semiconductor layers 326 and the insulating layer 321. A passivation layer 341 is formed on the insulating layer 321, the first source electrode 338, the first drain electrode 335, the second source electrode 336, and the second drain electrode 337. A first contact hole 344 corresponding to the first drain electrode 335 and a second contact hole 345 corresponding to the second drain electrode 345 are formed in the passivation layer 341. A first pixel electrode 354, a second pixel electrode 355, a second gate electrode 357, and a second gate line 359 are formed on the passivation layer 341. The first pixel electrode 354 is connected to the first drain electrode 335 via the first contact hole 344. The second pixel electrode 355 is connected to the second drain electrode 337 via the second contact hole 345. The second gate line 359 is connected to the second gate electrode 357. The second gate electrode 357 corresponds to the semiconductor layer 326. Unlike the TFT substrate 200 of the first embodiment, one of two TFTs in one pixel is a so-called top-gate type TFT. Thus, the second gate line 359 and the second gate electrode 357 are located on a same layer so that they are directly connected without needing a third contact hole. The TFT substrate 300 has advantages similar to those of the TFT substrate 200.

In further and/or alternative embodiments, the first gate line may have a same width as the corresponding second gate line, and the first and second gate lines may be overlapped one on the other either partially or wholly.

It is to be understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A thin film transistor (TFT) substrate, comprising:
a plurality of first gate lines parallel to each other,
a plurality of second gate lines parallel to each other and parallel to the first gate lines, and being disposed on one or more layers different from a layer of the first gate lines,
a plurality of data lines intersecting with the first and second gate lines,
a plurality of first pixel electrodes and second pixel electrodes, and
a plurality of first TFTs and a plurality of second TFTs,
each first pixel electrode being connected to one of the first gate lines and one of the data lines via one of the first TFTs, and each second pixel electrode being connected to one of the second gate lines and one of the data lines via one of the second TFTs, wherein each of the first gate lines overlaps a corresponding one of the second gate lines.

2. The TFT substrate of claim 1, wherein each of the first gate lines partly overlaps the corresponding second gate line.

3. The TFT substrate of claim 1, wherein each of the first gate lines completely overlaps the corresponding second gate line.

4. The TFT substrate of claim 3, wherein each of the first gate lines has a same width as the corresponding second gate line.

5. The TFT substrate of claim 1, further comprising a plurality of first contact holes, a gate electrode of each of the second TFTs being connected to the corresponding second gate line via a corresponding one of the first contact holes.

6. The TFT substrate of claim 5, wherein the second gate line partly overlaps the gate electrode of the second TFT, and the first contact hole corresponds to an area where the gate electrode of the second TFT underlies the second gate line.

7. The TFT substrate of claim 6, further comprising a plurality of second contact holes and a plurality of third contact holes, a drain electrode of each of the first TFTs being connected to the corresponding first pixel electrode, and a drain electrode of each of the second TFTs being connected to the corresponding second pixel electrode.

8. The TFT substrate of claim 1, wherein each of the second TFTs is a top-gate type TFT, the corresponding second gate line and a gate electrode of the second TFT being on a same layer and directly connected to each other.

9. A method for manufacturing the TFT substrate of claim 1, the method comprising:
providing a substrate,
forming a first gate electrode, a second gate electrode, and a first gate line on the substrate,
forming an insulating layer on the first gate electrode, the second gate electrode, the first gate line, and the substrate,
forming semiconductor layers on the insulating layer,
forming a first drain electrode, a first source electrode, a second drain electrode, a second source electrode, and data lines,
forming a passivation layer on the first drain electrode, the first source electrode, the second drain electrode, the second source electrode, the data lines, and the insulating layer,
forming a first contact hole, a second contact hole, and a third contact hole through the passivation layer, and
forming a first pixel electrode, a second pixel electrode, and a second gate line, the first pixel electrode, the second pixel electrode, and the second gate line being connected to the first drain electrode, the second drain electrode, and the second gate electrode via the first, the second, and the third contact holes respectively.

10. The method of claim 9, wherein the second gate line is made from a same material as the first and second pixel electrodes.

11. The method of claim 10, wherein the second gate line and the first and second pixel electrodes are made from one of indium tin oxide (ITO) and indium zinc oxide (IZO).

12. The method of claim 9, wherein the first gate line, the first gate electrode, and the second gate electrode are made from a same material, which includes any one or more items selected from the group consisting of aluminum (Al), molybdenum (Mo), titanium (Ti), copper (Cu), chromium (Cr), and tantalum (Ta).

13. A method for manufacturing the TFT substrate of claim 1, the method comprising:
providing a substrate,
forming a first gate electrode and a first gate line on the substrate,
forming an insulating layer on the first gate electrode, the first gate line, and the substrate,
forming semiconductor layers on the insulating layer,
forming a first drain electrode, a first source electrode, a second drain electrode, a second source electrode, and data lines,
forming a passivation layer on the first drain electrode, the first source electrode, the second drain electrode, the second source electrode, the data lines, and the insulating layer,
forming a first contact hole and a second contact hole through the passivation layer, and
forming a first pixel electrode, a second pixel electrode, a second gate electrode, and a second gate line on the passivation layer, the second gate line being directly connected to the gate electrode.

14. The method of claim 13, wherein the first pixel electrode and the second pixel electrode are connected to the first drain electrode and the second drain electrode via the first and second contact holes, respectively.

15. The method of claim 13, wherein the second gate line and the second gate electrode are made from a same material as the first and second pixel electrodes.

16. The method of claim 15, wherein the second gate line, the second gate electrode, and the first and the second pixel electrodes are made from one of indium tin oxide (ITO) and indium zinc oxide (IZO).
